(19) United States
(12) Patent Application Publication
(10) Pub. No.: US 2008/0106104 A1
(43) Pub. Date: May 8, 2008

(54) Fire-Blocking Door Lock Structure

(75) Inventor: Ching-Tien Lin, Taipei Hsien (TW)

Correspondence Address: SHOEMAKER AND MATTARE, LTD, 10 POST OFFICE ROAD - SUITE 110, SILVER SPRING, MD, 20910, US

(73) Assignee: THASE ENTERPRISE CO., LTD., Taipei Hsien (TW)

(21) Appl. No.: 11/928,389

(22) Filed: Oct. 30, 2007

(30) Foreign Application Priority Data
Nov. 3, 2006 (TW) 095140679

(51) Int. Cl. E05B 65/10

(52) U.S. Cl. 292/92

(57) ABSTRACT

A push handle locking mechanism for a fire-blocking door lock structure is disclosed, including a handle frame member and a push handle mounted in the handle frame member. The push handle locking mechanism consists of a fixing base installed in the frame member for connecting with the push handle and having a related-actuation portion; a pressing member pivotally disposed on the fixing base for pressing the related-actuation portion; an unlatched maintaining member movably disposed on the fixing base; and a first latching assembly and a second latching assembly disposed on the fixing base corresponding to the second and third positioning portions to selectively restrict the displacement path of the unlatched maintaining member. The unlatched member is movably disposed on the fixing base to eliminate a welding problem known in the prior art, and, further, the first and second latching assemblies provide optional usage as desired.

### FIELD OF THE INVENTION

The present invention relates to lock structures, and more particularly, to an improved lock structure for a push handle locking mechanism for a fire-blocking door.

### BACKGROUND OF THE INVENTION

The installation of a fire-blocking door within a building primarily serves as a partition separating each floor between the stairwells. A lock structure used in a fire-blocking door is to allow fast opening of the door when an emergency occurs and to assure lockup of the fire-blocking door during a fire. The fire-blocking door equipped with a fire-blocking lock structure is usually in a closed state for preventing the spreading of flames to other floors during a fire. Prior art techniques related to this type of lock structures can be found in, for example, U.S. Pat. No. 7,070,210, U.S. Pat. No. 7,044,510, U.S. Pat. No. 7,000,954, and U.S. Pat. No. 6,860,528.

Typically, a conventional fire-blocking lock is installed on an inner portion of a door, and has a push handle levelly disposed at the center of the door. As shown in FIG. 1, a fire-blocking door lock comprises a handle frame member 10 horizontally disposed at substantially the center of the door and a push handle 101 installed within the handle frame member 10, wherein two fixed bases 103 are pivoted to the bottom surface of the a handle frame base 10 by a screw and connected to the push handle 101. The fire-blocking lock can be unlatched when a person presses a push handle 10 mounted on a frame member 10 that is horizontally mounted at the center of the fire-blocking door. When the push handle 101 is pressed down, a retractable latch body 201 is withdrawn to the inside of a casing 20, unlatching the fire-blocking door lock to open the door.

Also, as shown in FIG. 1, the frame member 10 further comprises a latching member 105 substantially level with the surface of the push handle 101, and a retaining piece 107 welded on one side of the push handle 101. The latching member 105 consists of a tongue piece 1051 and the retaining piece 107 is provided with a fixing groove 1071 for receiving and positioning the tongue piece 1051 therein. To maintain the fire-blocking door in a constantly unlatched status, a key or a hex-wrench (a key in this embodiment) is used to insert into the latching member 105 (a core lock in this embodiment) to rotate the tongue piece 1051 to the fixing groove 1071 for fixing the tongue piece 105 1 therein, and the push handle 101 is kept pressed down by pressing the retaining piece 107 to retract the latch body 201, unlatching the fire-blocking door lock to open the door.

However, when welding the retaining piece 107 for the push handle 101, the retaining piece 107 has to be made precisely level in order to unlatch the door smoothly, since a tilting or uneven surface of the retaining piece 107 can cause difficulty to open the door in an emergency. For example, the push handle 101 is unable to move in a downward direction to the position of the latch body 201 if the retaining piece 107 is declined from level. Or, the tongue piece 1051 cannot be rotated into the fixing groove 1071 if the retaining piece 107 is inclined from level, failing to unlatch the door lock due to the deviation from level in the position of retaining piece 107. Even if the retaining piece 107 merely deviates slightly from level, its non-level surface might easily cause the latch body 201 to fail to retract sufficiently or the push handle 101 unable to move to a position sufficient enough to allow for the retraction of the latch body 201. As such, the conventional technique is disadvantageous in use in that it raises safety concerns of failing to assure fast opening of the door when an emergency occurs and to assure lockup of the fire-blocking door during a fire.

Moreover, there also exists a difficulty in trying to keep the welded retaining piece precisely level, resulting in an inadequate and unsatisfactory yield. Further, the defective product can only be found after being assembled and the smoothness of the product cannot be accurately detected and assured during the welding process, thus necessitates using a testing device, increasing manufacturing costs as a result.

In addition, the prior technique discussed above only permits the use of a key or a hex-wrench to unlatch the door lock but does not provide a flexible design that allows for an alternative and optional use according to the preference of the user. Therefore, there exists a need to provide an improved door lock that not only provides for flexible use but also assures fast and easy opening of the door when an emergency occurs to assure lockup of the fire-blocking door during a fire.

### SUMMARY OF THE INVENTION

An objective of the present invention is to provide a fire-blocking door lock structure that latches the push handle of a fire-blocking door to assure an unlatched status for fast opening of the door when an emergency occurs and maintains a lockup status of the lock structure when the fire-blocking door is closed, so as to eliminate the possibility that the door lock is accidentally unlatched or opened by someone who is unaware of the fire.

Another objective of the present invention is to provide a fire-blocking door lock structure that can provide flexibility in use.

Another objective of the present invention is to provide a fire-blocking door lock structure that saves the manufacturing cost and thus the time required.

To achieve the above and other objectives, the present invention provides a push handle locking mechanism for a fire-blocking door lock structure comprising a handle frame member and a push handle mounted in the handle frame member. The push handle locking mechanism comprises a fixing base installed in the frame member for connecting with the push handle and having a related-actuation portion; a pressing member pivotally disposed on the fixing base for pressing the related-actuation portion; an unlatched maintaining member movably disposed on the fixing base and comprising a first positioning portion disposed on one end thereof for fixing the pressing member, a second positioning portion disposed at a position away from the first positioning portion, and a third positioning portion disposed between the first positioning portion and the second positioning portion; a first latching assembly disposed on the fixing base corresponding to the second positioning portion to selectively restrict the displacement path of the unlatched maintaining member; and a second latching assembly disposed on the fixing base corresponding to the third positioning portion to selectively restrict the displacement path of the unlatched maintaining member.

In one preferred embodiment, the related-actuation portion is a pin member for use in the push handle locking mechanism of the fire-blocking door lock structure.

The fixing base further comprises a slide portion, an angle limiting portion, a first limit portion, a second limit portion, and a third limit portion extending from the bottom surface thereof. The slide portion is an inclined groove, and the angle-limiting portion is an opening preferably in a three-quarter-circle shape. The first limit portion, the second limit portion, and the third limit portion are projecting pillars.

The pressing member is a metallic pressing member mounted across and above the related-actuation portion, and further comprises a connecting portion for pivotally mounting on the fixing base, an elastic portion disposed on the connecting portion and a stair-like portion bending downwards and mounted at a position away from the connecting portion, wherein the elastic portion is a spiral spring.

The first positioning portion, after bending upwards on one end of the unlatched maintaining member, extends levelly to form a stair-like shape, and the height of the bending of the first positioning portion is smaller than the stair-like portion, wherein the unlatched maintaining member is a metallic pressing member. The second positioning portion is disposed at a position away from the other end of the first positioning portion and is a sharp protrusion in a V shape. The third positioning portion is an opening and preferably in a semi-oval shape.

The unlatched maintaining member further comprises a first sliding-member slot corresponding to the first limit portion, a maintaining portion bending upwards from the second positioning portion and extending levelly towards the third positioning portion, a second sliding-member slot disposed between the second positioning portion and the third positioning portion to correspond to the second limit portion, and a restoring storage portion disposed to cover the maintaining portion, wherein the maintaining portion is an L-shaped section and the restoring storage portion is a spiral spring.

The first locking assembly comprises a rotor corresponding to the third positioning portion and a first fixing portion for fixing the rotor on the fixing base, wherein the rotor comprises a second fixing portion disposed on a bottom end thereof to correspond to the third positioning portion, a third fixing portion coaxially sharing the same core shaft with the second fixing portion, and a first locking portion for lockup.

The first fixing portion comprises a connecting portion for correspondingly coupling to the fixing base, an opening portion for allowing the first portion to protrude from the first locking portion, and a fourth limit portion for the insertion of the maintaining portion.

The second locking assembly comprises a limiting member corresponding to the second positioning portion, and a second locking portion for actuating the limiting member, wherein the limiting member comprises a groove or slot shaped to correspond to the second positioning portion, a pair of sliding-member slots corresponding to the third limit portion, and a positioning pillar for allowing the second locking portion to actuate, wherein the second locking portion is a core lock comprising a lock tongue.

Compared to the prior art technique, the distinguishing feature of the fire-blocking door lock structure of the present invention is the use of a pressing member to push the related actuation portion to secure the locking of the push handle and thus assure an unlatched effect when the door is in use, and also the use of an unlatched maintaining member to keep the pressing member on the related-actuation portion that allows for an optional use of a first locking assembly or a second locking assembly to restrict the displacement path of the unlatched maintaining member, thus satisfying the installation requirement of using a hex-wrench or a key at will to control the latching status. Also, as this modularized design can meet different installation needs and has flexibility in usage, the manufacturing cost and the time required can be saved. Therefore, the present invention offers advantages over the prior techniques and thus has high industrial applicability.

### BRIEF DESCRIPTION OF THE DRAWINGS

Further characteristics and advantages of the invention will be more apparent from reading the following detailed description, which has been provided as a non-limiting example and has been made with reference to the appended drawings, in which:

FIG. 1 (PRIOR ART) is a perspective view of a conventional fire-blocking door lock;

FIG. 2 is a perspective view of a preferred embodiment of the push handle latching mechanism for fire-blocking door usage according to the present invention;

FIG. 3 is an exploded view showing the structure of the push handle latching mechanism being applied to a fire-blocking door according to the present invention;

FIGS. 4A and 4B are an enlarged perspective views showing partial components of the push handle latching mechanism for fire-blocking door usage according to the invention, wherein, FIG. 4A illustrates the structure of the unlatched maintaining member, and FIG. 4B depicts the structure of the rotor of the first locking assembly.

FIGS. 5A and 5B are perspective views showing the status of using the first locking assembly to restrict the displacement paths of the unlatched maintaining member, wherein FIG. 5A shows the pressing member releasing the related-actuation portion and unlatching the push handle, and FIG. 5B depicts the pressing member pressing the related-actuation portion to lock the push handle.

FIGS. 6A and 6B are other perspective views showing the use of the second locking assembly to restrict the displacement paths of the unlatched maintaining member, wherein FIG. 6A shows the pressing member releasing the related-actuation portion to unlatch the push handle, and FIG. 6B depicts the pressing member pressing the related-actuation portion to lock the push handle; and

FIGS. 7A and 7B are perspective views showing the dual-use design of the push handle latching mechanism for fire-blocking door usage according to the present invention; wherein FIG. 7A shows the use of the first locking assembly to restrict the displacement paths of the unlatched maintaining member; and FIG. 7B shows the use of the second locking assembly to restrict the displacement path of the unlatched maintaining member.

### DETAILED DESCRIPTION OF THE PREFERRED EMBODIMENTS

The present invention is described in the following so that one skilled in the pertinent art can easily understand other advantages and effects of the present invention. Note that the drawings provided herein are all simplified perspective views illustrating the basic structure of the present invention and the components applied are not limited to what is shown in the preferred embodiments. The present invention may also be implemented and applied according to other embodiments, and the details may be modified based on different views and applications without departing from the spirit of the invention.

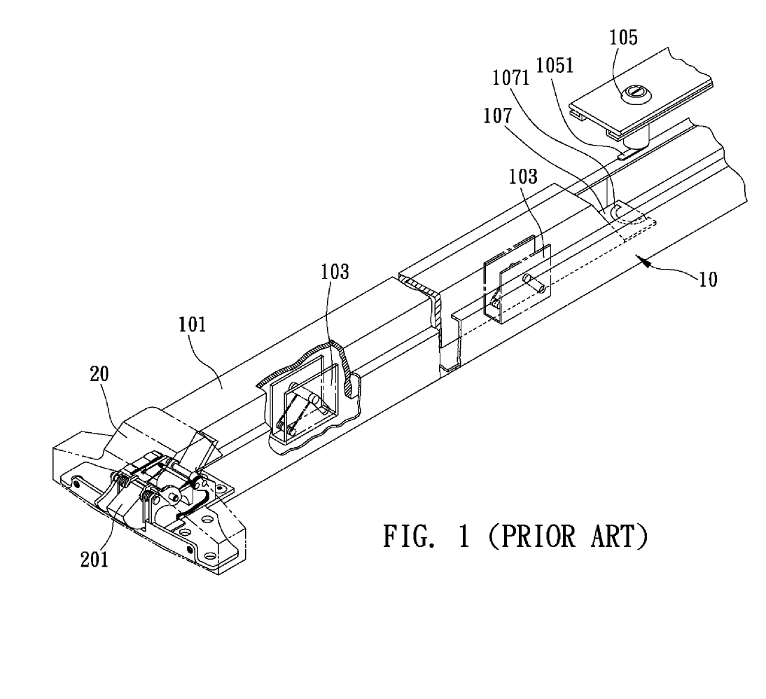

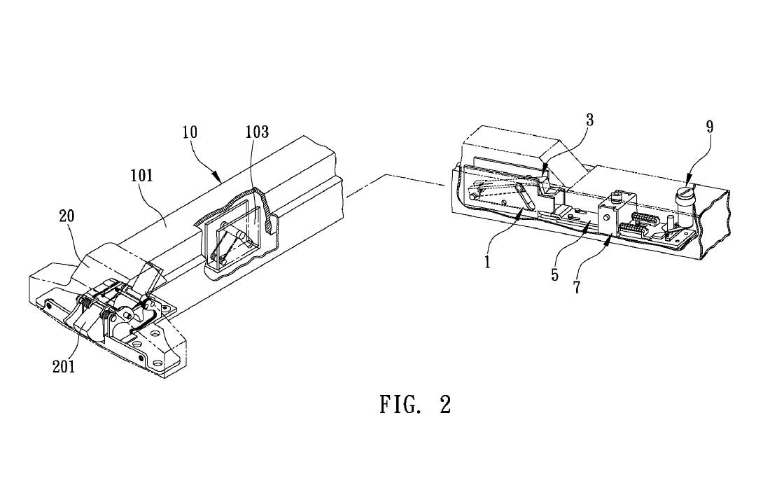

FIGS. 2 through 7B are perspective views showing the structure of the preferred embodiments of the fire-blocking door lock structure according to the present invention. As shown in FIG. 2, the fire-blocking door lock structure according to the present invention is applied to a fire-blocking door. The fire-blocking door using the fire-blocking door lock structure described in the embodiments of the invention is the same as the conventional fire-blocking door that the lock structure in FIG. 1 is applied to, and does not otherwise enter into the invention, and therefore it is not illustrated in the drawings herein. Similar to FIG. 1, the fire-blocking door lock structure according to the present invention comprises a handle frame 10, a push handle 101 installed in the handle frame member 10, and an improved fixing base 103 disposed at a position away from the latching member 201.

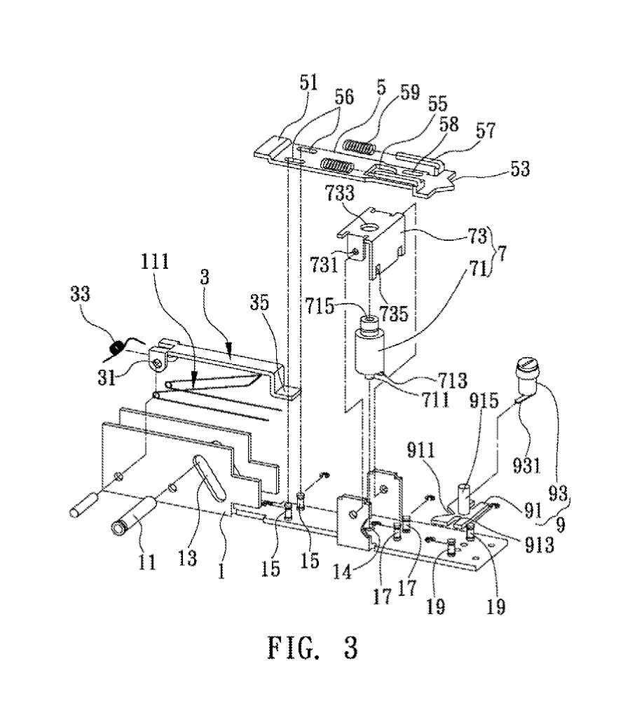

In this embodiment, as shown in FIGS. 2 and 3, the push handle latching mechanism of the present invention comprises a fixing base 1 installed in the frame member 10 for connecting the push handle 101, the fixing base 1 being provided with a related-actuation portion 11 for moving with respect to the push handle 101; a pressing member 3 pivotally disposed on the fixing base 1 for pressing the related-actuation portion 11; an unlatched maintaining member 5 movably disposed on the fixing base 1 and comprising a first positioning portion 51 disposed on one end thereof for fixing the pressing member 3, a second positioning portion 53 disposed at a position away from the first positioning portion 51, and a third positioning portion 55 disposed between the first positioning portion 51 and the second positioning portion 53; a first latching assembly 7 disposed on the fixing base 1 corresponding to the second positioning portion 53 to selectively restrict the displacement path of the unlatched maintaining member 5; and a second latching assembly 9 disposed on the fixing base 1 corresponding to the third positioning portion 55 to selectively restrict the displacement path of the unlatched maintaining member 5 as well.

The related-actuation portion 11 can be, for example, a pin member. The fixing base 1 further comprises a slide portion 13, an angle limiting portion 14, a first limit portion 15, a second limit portion 17, and a third limit portion 19 extending from the bottom surface thereof. The slide portion 13 may be an inclined groove, and the angle-limiting portion 14 is an opening, preferably in a three-quarter-circle shape but not limited to that shape. The first limit portion 15, the second limit portion 17, and the third limit portion 19 may be projecting pillars or other equivalent structures. The related-actuation portion 11 penetrates through the slide portion 13 and the push handle 101 to connect the fixing base 1 with the push handle 101. The use of a spring 111 provides the elasticity for maintaining the position above the slide portion 13, allowing the push handle 101 to spring back after being pushed and to move along with the related-actuation portion 11 to generate related actuation of the latching member 201 when the user pushes the push handle 101. The technique of the push handle 101 related actuation of the latching member 202 is well known in the art, and therefore not further described herein for brevity and clarity.

The pressing member 3 may be a metallic pressing member mounted across and above the related-actuation portion 11 and may further comprise a connecting portion 31 for pivotally mounting on the fixing base 1, an elastic portion 33 disposed on the connecting portion 31, and a stair-like portion 35 bending downwards and mounted at a position away from the connecting portion 31, wherein the elastic portion may be a spiral spring and other equivalent structures. Thereby, the push force of the user on the push handle 101 presses down the pressing member 3 and thus causes the related-actuation portion 11 mounted in the slide portion to incline inwardly and change position while the elastic portion 33 maintains the elasticity of pressing down the pressing member 3.

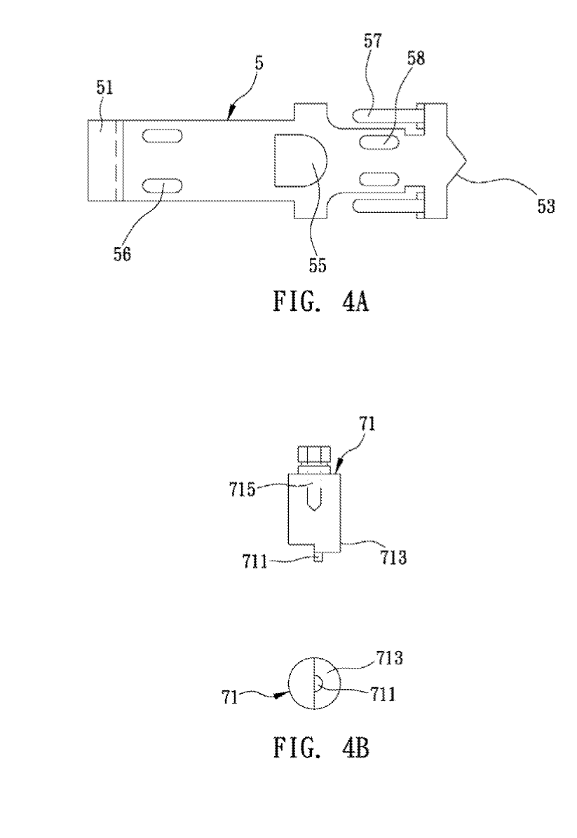

As shown in FIG. 4A with reference to FIG. 3, the unlatched maintaining member 5 may be a metallic pressing member. The first positioning portion 51, after bending upwards on one end of the unlatched maintaining member 5, extends levelly to form a stair-like shape, and the height of the bending of the first positioning portion 51 is smaller than the stair-like portion 35 of the pressing member 3 to press the stair-like portion 35. The second positioning portion 53 is disposed on the unlatched maintaining member 5 at a position away from the other end of the first positioning portion 51 and is a V-shaped sharp protrusion. The third positioning portion 55 is preferably an opening in a semi-oval shape but is not limited to this configuration.

Further, the unlatched maintaining member 5 may comprise a first sliding-member slot 56 corresponding to the first limit portion 15, a maintaining portion 57 bending upwards from the second positioning portion 53 and extending levelly towards the third positioning portion 57, a second sliding-member slot 58 disposed between the second positioning portion 53 and the third positioning portion 57 to correspond to the second limit portion 17, and a restoring storage portion 59 disposed to cover the maintaining portion 57, wherein the maintaining portion 57 is an L-shaped section and the restoring storage portion 59 is a spiral spring and other equivalent structures.

The first locking assembly 7 comprises a rotor 71 corresponding to the third positioning portion 55 and a first fixing portion 73 for fixing the rotor 71 on the fixing base 1, wherein the rotor 71 comprises a second fixing portion 711 disposed on a bottom end thereof to correspond to the third positioning portion 713, a third fixing portion 713 sharing the same core shaft with the second fixing portion 711, and a first locking portion 715 for lockup by the insertion of a locking member such as a hexagonal wrench (not shown). The second fixing portion 711 is in a hemisphere shape and the angle-limiting portion 14 can limit its turning angles. Note that the shape of the second fixing portion 711 corresponds to that of the angle-limiting portion 14, which can limit the turning angle of the second fixing portion 711 to 90 degrees and is in the shape of a three-quarter round shape or other shapes of functionally equivalent structures. The third fixing portion 713 is a hemisphere round shape that is bigger than the second fixing portion 711. Note that the shape is not limited to the above disclosure but include other equivalent structures that can accommodate and rotate in the third positioning portion 55. The first fixing portion 73 has a connecting portion 731 for correspondingly connecting with the fixing base 1, an opening portion 733 for exposing the first locking portion 715, and a fourth limiting portion 735 for the insertion of the maintaining portion 57 to prevent detachment of the restoring storage portion 59.

The second locking assembly 9 comprises a limiting member 91 corresponding to the second positioning portion 53, and a second locking portion 93 for actuating the limiting member 91, wherein the limiting member 91 comprises a notch 911 shaped to correspond to the second positioning portion 53, a pair of sliding-member slots 913 corresponding to the third limit portion 19, and a positioning pillar 915 for actuating the second locking portion 93, wherein the second locking portion 93 is a core lock comprising a lock tongue 931 for the insertion of the second locking portion 93 to correspondingly rotate the lock tongue 931 and push the positioning pillar 915. The structure of a core lock is well known in the art and thus will not be further described herein for brevity.

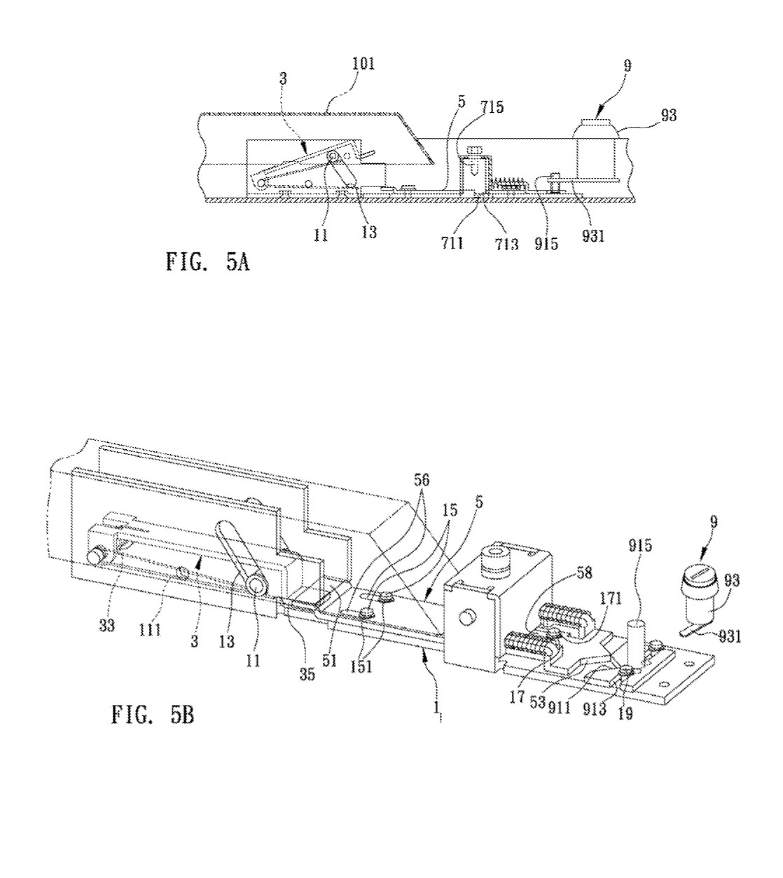

After assembling the constituent components described above, as shown in FIG. 5, the related-actuation portion 11 is located above the slide portion 13 and abuts against the pressing member 3. When the push handle 101 is pushed, it presses the pressing member 3 to move the lock 201 mounted in the lock casing 20, thus causing the retraction of the lock 201 to unlatch the fire-blocking lock and the door. The elasticity of the elastic portion 33 allows the pressing member 3 to be pressed down to the bottom, as depicted in FIG. 5B.

To maintain an unlatched status of the fire-blocking door, the second locking assembly 9 can be used to limit the displacement path of the unlatched maintaining member 5. As shown in FIG. 5B, when a key (not shown) is inserted into the second locking portion 93 (a core lock in this embodiment), the lock tongue 931 is turned to poke the positioning pillar 915 to move towards a side thereof, thus allowing the sliding-member slots 913 to correspondingly position on the third limiting portion 19, the second positioning portion 53 to detach from the notch 911 to move towards the pressing member 3, and the limiting member 91 to abut against the second positioning portion 53 to keep the unlatched maintaining member 5 from moving. Thus, the first positioning portion 51 presses the stair-like portion 35 thereof to keep the pressing member 3 pressed against the related-actuation portion 11 that keeps the retraction of the lock 201 and the unlatched status of the fire-blocking door.

To release the unlatched status of the fire-blocking door, the user may insert a key into the second locking portion 93 to turn the lock tongue 931 and move the positioning pillar 915 towards the other side, and at this time, the limiting member 91 does not abut against the second positioning portion 53, which then enters into the notch 911, and the elasticity of the restoring storage portion 59 allows the unlatched maintaining member 5 to move towards the second locking assembly 9 to detach the stair-like portion 35 from the first positioning portion 51. The spring 111 allows the related-actuation portion to return to its original position above the slide portion 13 that correspondingly moves the pressing member 3 back to its original position. The first limit portion 15 is configured to correspond to the first sliding-member slot 56 and the second limit portion 17 to the second sliding-member slot 58, and also C-shaped rings 151, 171 cover the first limit portion 15 and the second limit portion 17 respectively to hold the first limit portion 15 and the second limit portion 17 respectively in the first sliding-member slot 56 and the second sliding-member slot 58, allowing the unlatched maintaining member 5 to smoothly move on the fixing base 1.

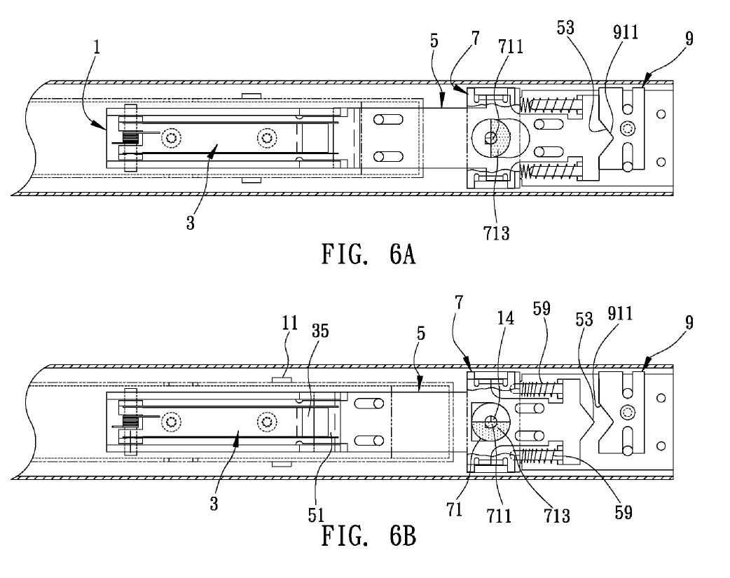

As shown in FIG. 6A, when the fire-blocking door is locked, the second fixing portion 711 and the third fixing portion 713 are located at the third positioning portion 55 and move towards the second positioning portion 53 which is received in the notch 911. As shown in FIG. 6B, when the first locking assembly 7 is chosen to restrict the displacement path of the unlatched maintaining member 5 to maintain the fire-blocking door in an unlatched condition, the user may insert a locking member such as a hexagonal wrench (not shown) into the second locking portion 93 to turn the rotor 71 that correspondingly moves the unlatched maintaining member 5 towards the pressing member 3 and enables the first positioning portion 51 to press on the stair-like portion 35, and the restoring storage portion 59 will be pressed by the motion of the unlatched maintaining member 5 towards the pressing member 3 for restoration, thereby assuring the related-actuation portion 11 being pressed by the pressing member 3 and thus the full retraction of the latching mechanism 201, and thus keep the fire-blocking door from being locked.

The second fixing portion 711 and the third fixing portion 713 are turned concurrently to move towards the right side (from viewing the perspective view) when the rotor 71 is turned, and the angle-limiting portion 14 limits the rotation angle of the second fixing portion 711 to about 90 degrees to prevent the idle running of the rotor 71 from turning without moving, but the angle is not necessarily limited to 90 degrees as disclosed herein, as other angles may be used. The hemisphere-shaped third fixing portion 713 is concurrently turned by about 90 degrees that converts the lengthwise length with respect to the unlatched maintaining member 5 into diameter, thereby pushing the third positioning portion 55 towards the pressing member 3 using the angle-limiting portion 14 as an axle and a pivot and moving the unlatched maintaining member 5 towards the left side from viewing the figure to assure the unlatched status of the fire-blocking door.

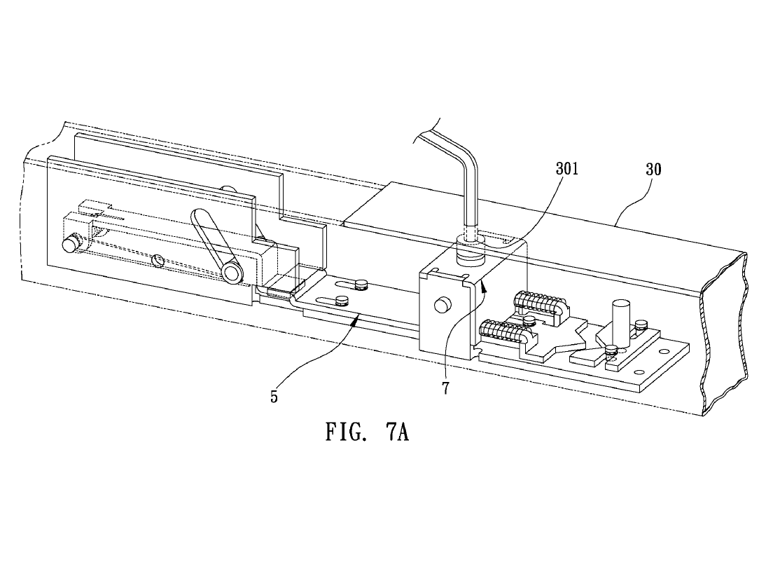

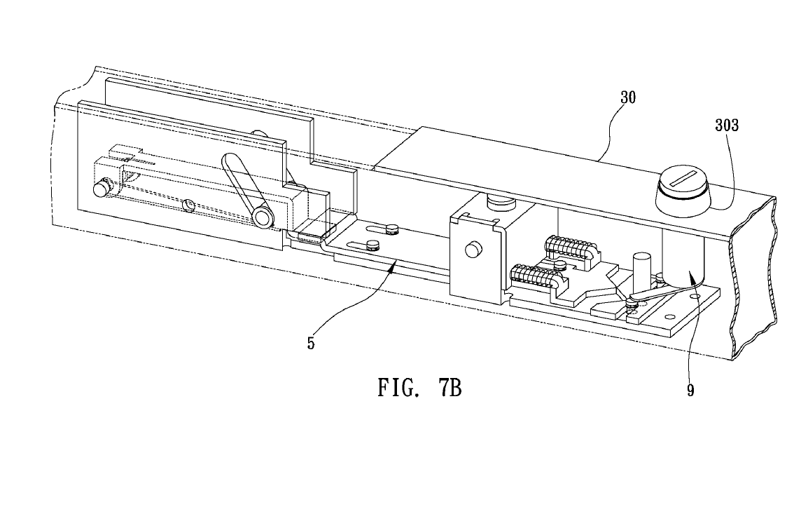

As shown in FIG. 7A, in this embodiment, when the first locking assembly 7 is applied in the push handle latching mechanism of the invention to limit the displacement path of the unlatched maintaining member 5, the cover member 30 can be formed with an opening 301 to allow the first locking assembly 7 to protrude from the surface of the first locking assembly 7. Similarly, as depicted in FIG. 7B, when the second locking assembly 9 is applied in the push handle latching mechanism of the invention to limit the displacement path of the unlatched maintaining member 5, the cover member 30 can be formed with an opening 303 such that the second locking assembly 9 can protrude from the surface of the second locking assembly 9. In other words, the push handle latching mechanism of the invention can be selectively applied to the use of a key or a hexagonal wrench, providing a modularized design of dual-use.

Compared to the prior art techniques, the distinguishing feature of the fire-blocking door lock structure of the present invention is an extension design extending from the fixing base and the use of a pressing member to press the related actuation portion to secure the locking of the push handle and thus assure an unlatched status when the door is in use, and also the use of an unlatched maintaining member to keep the pressing member on the related-actuation portion that allows for optional use of either the first locking assembly or the second locking assembly to restrict the displacement path, thus satisfying the installation requirement and preference to use either a hexagonal wrench or a key to control the latching status. Also, as this modularized design can meet different installation needs and has flexibility in design and usage, the manufacturing cost and time can be saved. Therefore, the present invention offers advantages over the prior techniques and thus has high industrial applicability.

What is claimed is:

1. A push handle locking mechanism for a fire-blocking door lock structure, the fire-blocking door lock structure comprising a handle frame member and a push handle mounted in the handle frame member, the push handle locking mechanism comprising:
a fixing base installed in the frame member for connecting with the push handle and having a related-actuation portion;
a pressing member pivotally disposed on the fixing base for pressing the related-actuation portion;
an unlatched maintaining member movably disposed on the fixing base and comprising a first positioning portion disposed on one end thereof for fixing the pressing member; a second positioning portion disposed at a position away from the first positioning portion; and a third positioning portion disposed between the first positioning portion and the second positioning portion;
a first latching assembly disposed on the fixing base corresponding to the second positioning portion to selectively restrict the displacement path of the unlatched maintaining member; and
a second latching assembly disposed on the fixing base corresponding to the third positioning portion to selectively restrict the displacement path of the unlatched maintaining member.

2. The push handle locking mechanism for a fire-blocking door lock structure according to claim 1, wherein the related-actuation portion is a pin member.

3. The push handle locking mechanism for a fire-blocking door lock structure according to claim 1, wherein the fixing base further comprises a slide portion, an angle-limiting portion, a first limit portion, a second limit portion, and a third limit portion extending from the bottom surface thereof.

4. The push handle locking mechanism for a fire-blocking door lock structure according to claim 3, wherein the angle-limiting portion is an opening.

5. The push handle locking mechanism for a fire-blocking door lock structure according to claim 3, wherein the angle-limiting portion is an opening in the shape of a three-quarter-circle.

6. The push handle locking mechanism for a fire-blocking door lock structure according to claim 3, wherein the slide portion is an inclined groove.

7. The push handle locking mechanism for a fire-blocking door lock structure according to claim 3, wherein the first limit portion, the second limit portion, and the third limit portion are projecting pillars.

8. The push handle locking mechanism for a fire-blocking door lock structure according to claim 1, wherein the pressing member is a metallic pressing member mounted across and above the related-actuation portion.

9. The push handle locking mechanism for a fire-blocking door lock structure according to claim 1, wherein the pressing member further comprises a connecting portion to be pivotally mounted on the fixing base, an elastic portion disposed on the connecting portion, and a stair-like portion bending downwards and mounted at a position away from the connecting portion.

10. The push handle locking mechanism for a fire-blocking door lock structure according to claim 9, wherein the elastic portion is a spiral spring.

11. The push handle locking mechanism for a fire-blocking door lock structure according to claim 9, wherein the first positioning portion, after bending upwards on one end of the unlatched maintaining member, extends levelly to form a stair-like shape, and the height of the bending of the first positioning portion is smaller than the stair-like portion.

12. The push handle locking mechanism for a fire-blocking door lock structure according to claim 1, wherein the unlatched maintaining member is a metallic pressing member.

13. The push handle locking mechanism for a fire-blocking door lock structure according to claim 1, wherein the second positioning portion is a sharp protrusion in a V-shape.

14. The push handle locking mechanism for a fire-blocking door lock structure according to claim 1, wherein the third positioning portion is an opening.

15. The push handle locking mechanism for a fire-blocking door lock structure according to claim 1, wherein the third positioning portion is an opening in a semi-oval shape.

16. The push handle locking mechanism for a fire-blocking door lock structure according to claim 1, wherein the fixing base further comprises a first limit portion and a second limit portion extending from the bottom surface thereof; and the unlatched maintaining member comprises a first sliding-member slot corresponding to the first limit portion, a maintaining portion bending upwards from the second positioning portion and extending levelly towards the third positioning portion, a second sliding-member slot disposed between the second positioning portion and the third positioning portion to correspond to the second limit portion, and a restoring storage portion disposed to cover the maintaining portion.

17. The push handle locking mechanism for a fire-blocking door lock structure according to claim 16, wherein the maintaining portion is an L-shaped section and the restoring storage portion is a spiral spring.

18. The push handle locking mechanism for a fire-blocking door lock structure according to claim 1, wherein the first locking assembly comprises a rotor corresponding to the third positioning portion and a first fixing portion for fixing the rotor on the fixing base.

19. The push handle locking mechanism for a fire-blocking door lock structure according to claim 18, wherein the rotor comprises a second fixing portion disposed on a bottom end thereof to correspond to the third positioning portion, a third fixing portion coaxially sharing the same core shaft with the second fixing portion, and a first locking portion for the insertion of a locking member for lockup; wherein the first fixing portion comprises a connecting portion for correspondingly coupling with the fixing base, an opening portion for allowing the first portion to protrude from the first locking portion, and a fourth limit portion for the insertion of the maintaining portion.

20. The push handle locking mechanism for a fire-blocking door lock structure according to claim 1, wherein the second locking assembly comprises a limiting member corresponding to the second positioning portion, and a second locking portion for actuating the limiting member.

21. The push handle locking mechanism for a fire-blocking door lock structure according to claim 20, wherein the fixing base further comprises a third limit portion and the limiting member comprises a groove shaped to correspond to the second positioning portion, a pair of sliding-member slots corresponding to the third limit portion, and a positioning pillar for allowing the second locking portion to actuate, wherein the second locking portion is a core lock comprising a lock tongue.
